(19) United States
(12) Patent Application Publication
(10) Pub. No.: US 2025/0123364 A1
(43) Pub. Date: Apr. 17, 2025

(54) POLARIZING OPTIC FOR COHERENT LIDAR

(71) Applicant: Lumentum Operations LLC, San Jose, CA (US)

(72) Inventor: Daniel John WAHL, Ottawa (CA)

(21) Appl. No.: 18/396,399

(22) Filed: Dec. 26, 2023

Related U.S. Application Data
(60) Provisional application No. 63/590,640, filed on Oct. 16, 2023.

(51) Int. Cl. G01S 7/481; G01S 7/4865; G01S 17/894; G02B 5/30; G02B 27/28; H01S 3/067

(52) U.S. Cl. CPC G01S 7/4814; G01S 7/4865; G01S 17/894; G02B 5/3016; G02B 27/283; H01S 3/06716

(57) ABSTRACT

In some implementations, an optical system for LIDAR sensing includes a transmitter configured to transmit a beam; a polarization beam splitter configured to block a first polarized transmission component of the beam and pass through a second polarized transmission component of the beam; a waveplate configured to convert the second polarized transmission component of the beam to a circular polarization state and to direct the beam toward a target, wherein the waveplate is configured to receive a return reflection of the beam and convert the return reflection to a second polarized reflection component, and wherein the polarization beam splitter is configured to reflect the second polarized reflection component and pass through a first polarized reflection component of the return reflection; a linear polarizer configured to pass through the second polarized reflection component; and a coherent receiver configured to receive the return reflection from the linear polarizer.

### CROSS-REFERENCE TO RELATED APPLICATION

This Patent Application claims priority to U.S. Provisional Patent Application No. 63/590,640, filed on Oct. 16, 2023, and entitled “PRECISION COHERENT LIDAR USING POLARIZING OPTICS.” The disclosure of the prior Application is considered part of and is incorporated by reference into this Patent Application.

### TECHNICAL FIELD

The present disclosure relates generally to polarizing optics and to a polarizing optic for coherent light detection and ranging (LIDAR).

### BACKGROUND

LIDAR, which may sometimes by referred to as “light detection and ranging” can be used in various applications, such as generating high-resolution maps, controlling autonomous vehicles, analyzing objects, three-dimensional sensing, gesture recognition, and/or the like. For example, an electro-optical system that includes a LIDAR sensor can detect, analyze, and/or measure a distance to a target by illuminating the target with pulsed laser light and analyzing reflected pulses. The LIDAR sensor provides LIDAR data that is based on differences in pulse transmission and return times (e.g., time-of-flight (TOF)) and/or differences in pulse wavelengths associated with the points of the target. Such LIDAR data can be used to determine representations of the target, features of the target, and/or distances to features of the target.

### SUMMARY

In some implementations, an optical system for LIDAR sensing includes a transmitter configured to transmit an amplitude modulation beam; a polarization beam splitter configured to block a first polarized transmission component of the beam and pass through a second polarized transmission component of the beam; a waveplate configured to convert the second polarized transmission component of the beam to a circular polarization state and to direct the beam toward a target, wherein the waveplate is configured to receive a return reflection of the beam and convert the return reflection of the beam to a second polarized reflection component, and wherein the polarization beam splitter is configured to reflect the second polarized reflection component and pass through a first polarized reflection component of the return reflection of the beam; a linear polarizer configured to pass through the second polarized reflection component; and a coherent receiver configured to receive the return reflection of the beam from the linear polarizer.

In some implementations, an optical system includes a polarization beam splitter; a waveplate; a linear polarizer; a coherent receiver; and a transmitter to transmit an amplitude modulation beam along an optical path, wherein the optical path extends through the polarization beam splitter and the waveplate and toward a target, extends back through the waveplate, reflects off the polarization beam splitter, and extends through the linear polarizer to the coherent receiver.

In some implementations, a method includes transmitting, by a transmitter of an electro-optical system, a beam through a set of optics, wherein the set of optics includes: a polarization beam splitter configured to block a first polarized transmission component of the beam and pass through a second polarized transmission component of the beam; a waveplate configured to convert the second polarized transmission component of the beam to a circular polarization state and to direct the beam toward a target, wherein the waveplate is configured to receive a reflection of the beam and convert the return reflection of the beam to a second polarized reflection component, and wherein the polarization beam splitter is configured to reflect the second polarized reflection component and pass through a first polarized reflection component of the return reflection of the beam; and a linear polarizer configured to pass through the second polarized reflection component; and receiving, by a receiver of the electro-optical system, the return reflection of the beam from the linear polarizer; generating, by a controller of the electro-optical system, a LIDAR measurement of the target using an output of the receiver corresponding to the return reflection of the beam; and outputting, by an output component of the electro-optical system, information identifying the LIDAR measurement.

### BRIEF DESCRIPTION OF THE DRAWINGS

FIG. 1 is a diagram of an example optical system associated with a polarizing optic for coherent LIDAR.

FIG. 2 is a diagram of an example electro-optical system associated with LIDAR measurement using a polarizing optic.

FIGS. 3A-3C are diagrams of an example associated with LIDAR measurement using a polarizing optic.

FIG. 4 is a flowchart of an example process associated with polarizing optic for coherent LIDAR.

### DETAILED DESCRIPTION

The following detailed description of example implementations refers to the accompanying drawings. The same reference numbers in different drawings may identify the same or similar elements.

Electro-optical systems may be used for communication, measurement, imaging, gesture recognition, objection recognition, three-dimensional sensing, and/or the like. For example, a LIDAR system may be used to determine a distance between a transmitter of the LIDAR system and a target, such as an object, a geographic area, or a person (e.g., for gesture recognition). By combining many distance measurements of the target, the LIDAR system may generate a three-dimensional representation of the target. In one use case, LIDAR systems may be integrated into manufacturing lines to perform automated inspection of manufactured products. For example, a LIDAR system may generate a three-dimensional representation of a manufactured product and use the three-dimensional representation for control of an automated process (e.g., for controlling a robotic arm or pick-and-place machine) or for quality control. In such a use case, among other examples, the LIDAR system may image a target at high-speed sample rates. Since there may be a limited amount of time allotted for manufacturing a product, a single sensor, which is only capable of 1000 samples per second, will restrict the number of features, products, and/or regions of interest that can be measured by the single sensor. In another use case, LIDAR systems may be integrated into autonomous vehicles to perform object recognition for autonomous control of the autonomous vehicles. For example, a LIDAR system may generate a three-dimensional representation of an area around a vehicle and use the three-dimensional representation for collision avoidance or object recognition. In such a use case, among other examples, the LIDAR system may image a target at relatively long ranges (e.g., to ensure adequate time for LIDAR image processing and system control to respond to the detected object). Since the amount of returning light to the sensor is related to the distance of the object, objects that are located beyond a few meters require highly sensitive detectors, which may also be highly sensitive to sources of optical noise (e.g., that may degrade the measurement precision and/or accuracy).

One type of LIDAR system, which can be used for LIDAR measurement, is a pulsed LIDAR system. In a pulsed LIDAR system, the LIDAR system emits pulses of light of a configured length at a configured frequency and measures a response of the pulses. However, some frequencies, which can be used for pulsed LIDAR systems with high sample rates, are subject to power limitations associated with ensuring eye safety as well as precision and/or accuracy limitations associated with pulse length. At other frequencies, with reduced eye safety risk, pulsed LIDAR systems may achieve higher powers and associated longer ranges, but may have relatively slow sample rates and relatively low insensitivity to optical noise.

Another type of LIDAR system, which can be used for LIDAR measurement, is a coherent frequency modulated continuous wave (FMCW) LIDAR based technique. FMCW LIDAR may use coherent, continuous wave laser light to improve optical noise insensitivity relative to direct detection using pulsed LIDAR, including optical noise from other light sources (e.g., solar glare, incandescent light, or other LIDAR systems). Additionally, a LIDAR system that uses coherent light may avoid eye hazards associated with high peak powers. However, FMCW LIDAR may also have relatively low sample rates, which may hinder integration into, for example, manufacturing lines. Yet another type of LIDAR system, which can be used for LIDAR measurement, is an amplitude modulation continuous wave (AMCW) based technique. AMCW LIDAR may use a coherent, continuous wave laser with amplitude modulation to achieve high sample rates, high measurement precision, and high insensitivity to some sources of optical noise (e.g., solar glare, incandescent light, other LIDAR systems). However, AMCW LIDAR systems may have difficulties distinguishing phase at different distances as a result of object transparency, a presence of multiple surfaces, and a configuration of a receiver (e.g., a sensor) of the AMCW LIDAR system.

Some implementations described herein provide polarizing optics for signal interference reduction in precision coherent LIDAR systems. For example, an optical system for LIDAR sensing, such as an AMCW LIDAR system, may include a set of optical components, such as a high extinction ratio linear polarizer, a polarization beam splitter, or a waveplate, among other examples, disposed in an optical path to reduce signal interference. By including the set of optical components in the optical path, the optical system achieves an extinction ratio of, for example, at least 3000:1, thereby improving LIDAR distance measurement precision and range by resolving errors associated with back-reflection from other optics of the optical system. Furthermore, the set of optical components maintains a fixed polarization between the transmitter and receiver that results in the improvements to the range measurements associated with higher signal from targets, objects, or materials that do not fully depolarize light upon reflection. In some implementations, the optical system may include a liquid crystal waveplate designed into an optical enclosure window. By using a liquid crystal waveplate, the optical system may enable a larger viewing angle for optical sensing, thereby improving optical sensing performance.

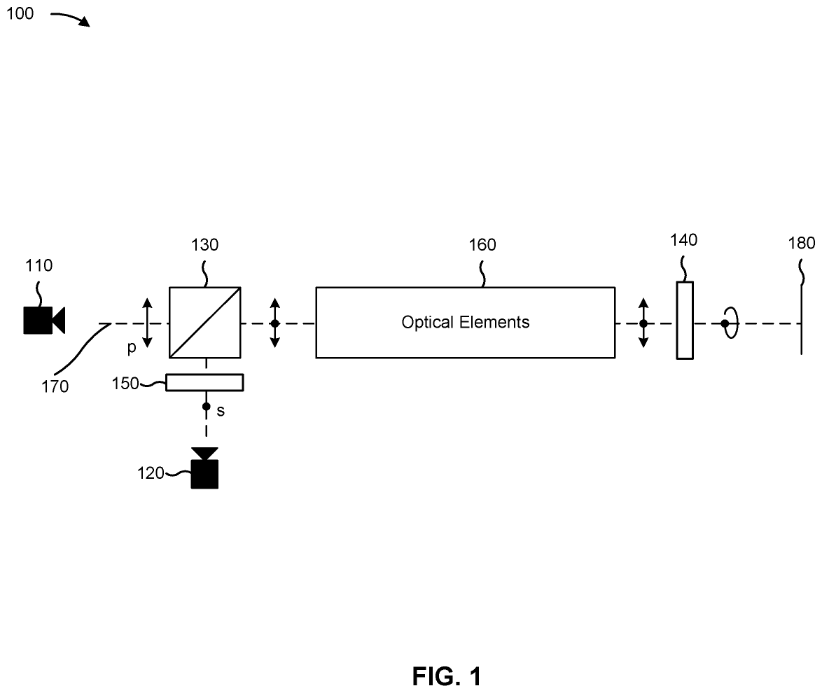

FIG. 1 is a diagram of an example optical system 100 associated with a polarizing optic for coherent LIDAR. As shown in FIG. 1, optical system 100 may include a transmitter 110, a receiver 120, and a set of polarizing optical components, which may include a polarization beam splitter 130, a waveplate 140, and a linear polarizer 150. In some implementations, the polarization beam splitter 130 and the linear polarizer 150 may be integrated into a single optical component or package. For example, the optical system 100 may include a linear polarizer with a polarization beam splitter (LP-PBS), which may include both a linear polarizer and a polarization beam splitter disposed on a common substrate or in a common package. In some implementations, the optical system 100 may include one or more other optical elements 160.

As further shown in FIG. 1, the transmitter 110, the receiver 120, the set of polarizing optical components (e.g., the polarization beam splitter 130, the waveplate 140, and the linear polarizer 150), and the one or more other optical elements 160 may be aligned along an optical path 170. For example, the optical transmitter 110 may transmit a beam along the optical path 170 and through the polarization beam splitter 130 in a first polarization state, such as a p-polarization state, as shown. The beam travels along the optical path 170 through the one or more other optical elements 160 and to the waveplate 140. The waveplate 140 may convert the beam to a circular polarization state and may direct the beam along the optical path 170 toward a target 180. In some implementations, the waveplate 140 may include a quarter waveplate (QWP) disposed at a configured angle relative to the electric field of the first polarization state in the optical path 170, such as a 45 degree angle among other examples. The beam may be back-scattered, by the target 180, and may reflect back, as a reflected beam, toward the waveplate 140 along the optical path 170.

The waveplate 140 may rotate the reflected beam to a second polarization state, such as an s-polarization state as shown, and direct the reflected beam toward the one or more other optical elements 160 along the optical path 170. In other words, although some implementations are described herein in terms of a p-polarization state and an s-polarization state, other polarization states are contemplated. For example, rather than the s-polarization state being passed through to the receiver 120, as described herein, and the p-polarization state being blocked, the p-polarization state may be passed through to the receiver 120 and the s-polarization state may be blocked.

The reflected beam travels along the optical path 170 to the polarization beam splitter 130. In this case, based on the reflected beam being in the s-polarization state, the polarization beam splitter 130 reflects the reflected beam along the optical path 170 toward the linear polarizer 150. In some implementations, a portion of the reflected beam may maintain the p-polarization state. For example, based on the waveplate 140 converting the reflected beam from the circular polarization state to the s-polarization state, some of the reflected beam that propagates to the polarization beam splitter 130 may be in the p-polarization state.

The position of the waveplate 140 with respect to the other optical elements 160 reduces the amount of undesired interference at the receiver. If the waveplate 140 is placed before other optical elements 160, the result may be back-reflections from the optical elements 160 returning in an s-polarization state rather than a p-polarization state, thereby causing interference with reflection from the target 180 that is also in the s-polarization state. Accordingly, the position of the waveplate 140 after the optical elements 160 causes the back-reflections from the optical elements 160 to be in the p-polarization state, which are removed from the reflected beam by the polarization beam splitter 130 and linear polarizer 150 to reduce the likelihood of interference.

The polarization beam splitter 130 ensures a high polarization extinction ratio beam is transmitted to cause a decrease in the amount of interference at the receiver. In some implementations, the transmit beam may include a portion of light that remains in the s-polarization state rather than the p-polarization state (e.g., as a result of imperfections in the generated polarization state from the polarization beam splitter). For example, the transmit beam may include p-polarization light and s-polarization light (e.g., because the polarization beam splitter does not fully remove the s-polarization light). When one or more optical elements 160 receive the p-polarized beam (e.g., from the transmitters 110 and the polarization beam splitter 130 and before the beam is incident on the target 180), the one or more optical elements 160 may pass the beam through toward the waveplate 140, as described above, and may back-reflect some of the beam toward the polarization beam splitter 130. In this case, the back-reflected portion of the beam (e.g., a return reflection) from the optical elements in the p-polarization state may have some light in the s-polarization state, which may interfere with the beam that has reflected off the target 180. Accordingly, the polarization beam splitter 130 may reduce the interference at the receiver 120 by ensuring a high extinction ratio towards the optical elements 160.

The polarization beam splitter 130 and linear polarizer 150 can reduce the amount of interference at the receiver 120 by removing p-polarization state light directed towards the receiver. In some implementations, the reflected beam may include light in a p-polarization state, which may result in interference at the receiver 120 (e.g., as a result of imperfections in the generated polarization state from the polarization beam splitter 130 and/or the linear polarizer 150 that allows a portion of p-polarization to the receiver 120). In this case, when the optical elements 160 return light in the p-polarization state towards the polarization beam splitter 130 and the linear polarizer 150, a portion of the beam in the p-polarization passes on to the receiver 120 and can cause interference with the reflected beam from the target 180. Additionally, or alternatively, the reflected beam may include light in the p-polarization state as a result of an introduction of interfering light from another source (e.g., solar glare, light bulbs, or another LIDAR system). Additionally, or alternatively, light that converts from s-polarization to p-polarization due to multiple reflection events at the target 180 may cause interference due to the extra distance from each reflection.

Based on the polarization beam splitter 130 receiving the reflected beam, the polarization beam splitter 130 passes through the portion of the reflected beam in the p-polarization state, rather than reflecting the portion of the reflected beam in the p-polarization state. For example, rather than reflecting the portion of the reflected beam in the p-polarization state, as occurs with the portion of the reflected beam in the s-polarization state as described above, the polarization beam splitter 130 may pass the portion of the reflected beam in the p-polarization state. In this way, the polarization beam splitter 130 reduces a likelihood of interfering p-polarization state light being incident on the receiver 120. In some implementations, an isolator (not shown) or another optical element may be positioned between the transmitter 110 and the polarization beam splitter 130 to absorb the portion of the reflected beam in the p-polarization state to avoid the portion of the reflected beam in the p-polarization state being incident on the transmitter 110.

The linear polarizer 150 receives the reflected beam in the s-polarization state and passes the reflected beam in the s-polarization state through toward the receiver 120. In some implementations, a portion of the reflected beam, which received from the polarization beam splitter, is in the p-polarization state rather than the s-polarization state. For example, as a result of incomplete polarization state selectivity of the polarization beam splitter 130, some light in the p-polarization state may be reflected by the polarization beam splitter 130 toward the receiver 120 rather than passed through (e.g., toward the transmitter 110 and to an isolator as described above). Additionally, or alternatively, other sources of interference (e.g., other optics or external sources) may result in some p-polarization state interfering light being directed toward the linear polarizer 150. In these cases, the linear polarizer 150 blocks the portion of the reflected beam in the p-polarization state (e.g., that has been reflected by the polarization beam splitter 130 toward the receiver 120).

In another configuration, elements of the optical system 100 may be arranged in another order. For example, a position of the linear polarizer 150 and the polarization beam splitter 130 may be switched, such that the transmitter 110 directs a beam toward the linear polarizer 150 and the polarization beam splitter 130 in the s-polarization state, and the beam is directed from the polarization beam splitter 130 toward the target 180. In this case, a reflection of the beam is directed back toward the polarization beam splitter 130 and a p-polarization portion of the reflection of the beam is passed through to the receiver 120 (e.g., without further passing through the linear polarizer 150).

The receiver 120 receives a remainder of the reflected beam, which has not been blocked by the linear polarizer 150. For example, the receiver 120 receives the reflected beam in the s-polarization state based on the polarization beam splitter 130 and the linear polarizer 150 having blocked portions of the reflected beam that are in the p-polarization state. In some implementations, the receiver 120 may be a coherent receiver (e.g., an optical hybrid detector). For example, the receiver 120 may combine local light from a local oscillator (e.g., a tap from the transmitter 110) with signal light (e.g., the remainder of the reflected beam to perform a measurement). In this case, the optical system 100 may include a splitting component to split the beam into a sample path (e.g., which is directed toward the target 180 and return-reflected toward the receiver 120) and a local oscillator path (e.g., which is directed toward the receiver 120 without reflection off the target 180). The receiver 120 may convert an optical in-phase (I) and quadrature-phase (Q) component of a return reflection of the beam to an analog signal.

The receiver 120 may perform a measurement on the received, reflected beam and a controller (not shown) may use the measurement to perform a determination. For example, a controller may use a LIDAR measurement, time-of-flight measurement, an amplitude measurement, or the like to perform a point-cloud determination of the target 180, an object recognition of the target 180, a gesture recognition of the target 180, or a three-dimensional sensing determination of the target 180, among other examples. In some implementations, the optical system 100 may generate a measurement of or a determination relating to the target 180 with a particular accuracy based on the presence of the polarization beam splitter 130, the waveplate 140, and/or the linear polarizer 150. For example, based on achieving an extinction ratio of, for example, at least 3000:1, the receiver 120 may have a noise floor that is reduced by, for example, up to 35 decibels (dB), thereby improving an accuracy of a measurement performed by the receiver 120 and removing the likelihood of artefacts that can be deleterious to the measurement.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

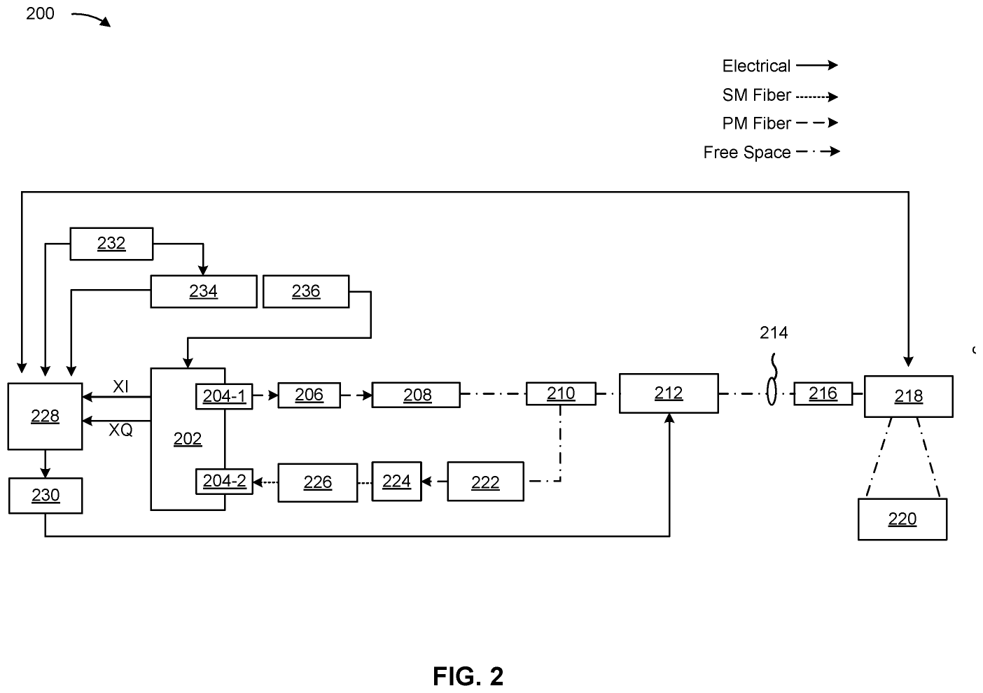

FIG. 2 is a diagram of an example electro-optical system 200 associated with LIDAR measurement using a polarizing optic. As shown in FIG. 2, the electro-optical system 200 may include an analog coherent optic (ACO) 202, a set of LC/UPC fiber connectors 204, a polarization maintaining erbium-doped fiber array (PM-EDFA) 206, a collimator lens 208, a polarization beam splitter 210, tunable focus component 212, an objective lens 214, a waveplate 216, a set of mirrors 218 aligned to a target 220 (e.g., a sample), a coupling lens 222, a fiber end 224, a polarization controller 226, a field programmable gate array (FPGA) system 228, a personal computer (PC) 230, a clock 232, RF synthesizers 234, and a RF combiner component 236.

One or more synthesizers 234 may generate an electrical signal associated with a radio frequency (RF) pattern for transmission toward the target 220. For example, a group of RF synthesizers 234 may generate electrical signals for a set of three sinusoidal tones of an RF signal and transmit the electrical signals to the FPGA system 228 for digitization. The RF combiner component 236 may encode the RF signal on an optical carrier with a Mach-Zehnder (MZ) modulator (MZM) and cause the ACO 202 to transmit an optical signal encoded with the RF signal. The clock 232 may generate a clock signal that synchronizes the one or more RF synthesizers 234 with a digitizer of the FPGA system 228.

The ACO 202 and the LC/UPC connectors 204-1 may transmit an output optical signal via an optical beam along a PM fiber toward the PM-EDFA 206. The PM-EDFA 206 may amplify the optical signal and convey the optical beam along the PM fiber toward the collimator lens 208. The collimator lens 208 may collimate the optical beam and cause the optical beam to be conveyed toward the polarization beam splitter 210 via free space. The polarization beam splitter 210 may pass through the optical beam (e.g., in a p-polarization state) and cause the optical beam to be conveyed toward the tunable focus component 212 via free space. The tunable focus component 212 may include one or more lenses to focus the optical beam and direct the optical beam toward the objective lens 214. A beam expander, which includes the tunable focus component 212 and the objective lens 214, may expand the optical beam and direct the optical beam toward the waveplate 216, which may be a quarter waveplate. The waveplate 216 may rotate the optical beam to a circular polarization state and direct the optical beam toward the set of mirrors 218. The set of mirrors 218 may include a set of two-dimensional Galvo mirrors that can scan the optical beam across the target 220 to obtain one or more back-reflections from portions of target sample 220 (e.g., from which a point-cloud or other representation of the target 220 is generated).

A reflected optical beam (e.g., reflected by the target 220) is directed through the waveplate 216 (e.g., via the set of mirrors 218). The waveplate 216 rotates a polarization state of the reflected optical beam to s-polarization state. An amount of loss associated with rotation to the s-polarization state by the waveplate 216 may be less than 0.1 dB. The waveplate 216 directs the reflected optical beam to the polarization beam splitter 210 (e.g., via the beam expander of the tunable focus component 212 and the objective lens 214 in free space), which reflects the s-polarization state component of the reflected optical beam and passes through a remaining p-polarization state component of the reflected optical beam (e.g., for extinction via an isolator (not shown)). The reflected optical beam (e.g., in the s-polarization state) is directed to the coupling lens 222, which focuses the reflected optical beam onto the fiber end 224. The fiber end 224 directs the reflected optical beam along a polarization maintaining (PM) fiber or a single-mode (SM) fiber toward the polarization controller 226, which may include a linear polarizer, as described above, or another polarization control component to pass through the s-polarization state component of the reflected optical beam and block a p-polarization state component of the reflected optical beam. The polarization controller 226 directs the reflected optical beam to the LC/UPC connector 204-2 of the ACO 202, where the reflected optical beam is detected by a detector of the ACO 202.

The detector of the ACO 202 may convert the RF pattern on the optical beam into electrical signals for sampling by the FPGA system 228 and/or the PC 230, such as an in-phase component (XI) and a quadrature component (XQ) of the optical beam in which to determine a measurement of the target where X is the polarization state. The electro-optical system 200 (e.g., using the FPGA 228 and/or the PC 230) may calculate a time-of-flight measurement, a velocity measurement, a distance measurement, or another measurement of the target 220. In some implementations, the electro-optical system 200 may use a sum-of-squares method applied to different optical receiver channels (e.g., the three signals that are modulated onto the optical beam) to stabilize the amplitude of the RF power of the reflected optical beam and account for optical phase shifts. The electro-optical system 200 may use a set of measurements of the target 220 (e.g., based on the set of mirrors 218 scanning the optical beam across the target 220) to generate a three-dimensional point cloud image representing the target 220. Based on generating the three-dimensional point cloud image, the electro-optical system 200 may generate a control signal (e.g., for controlling a quality control manufacture line or for controlling an autonomous vehicle).

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

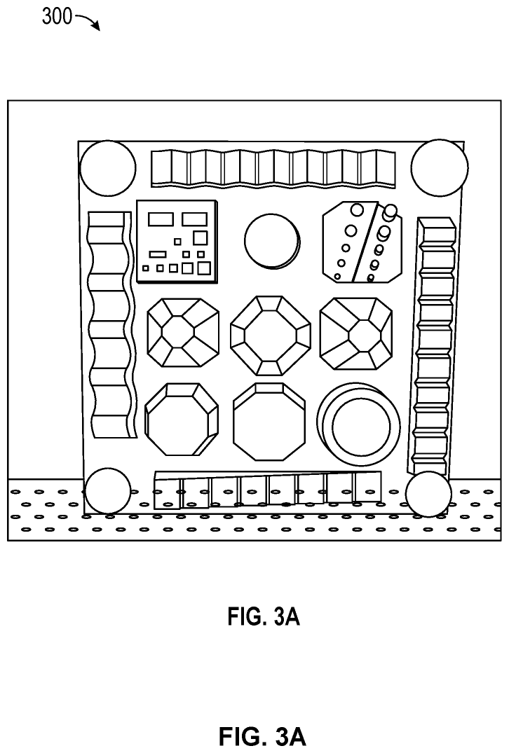

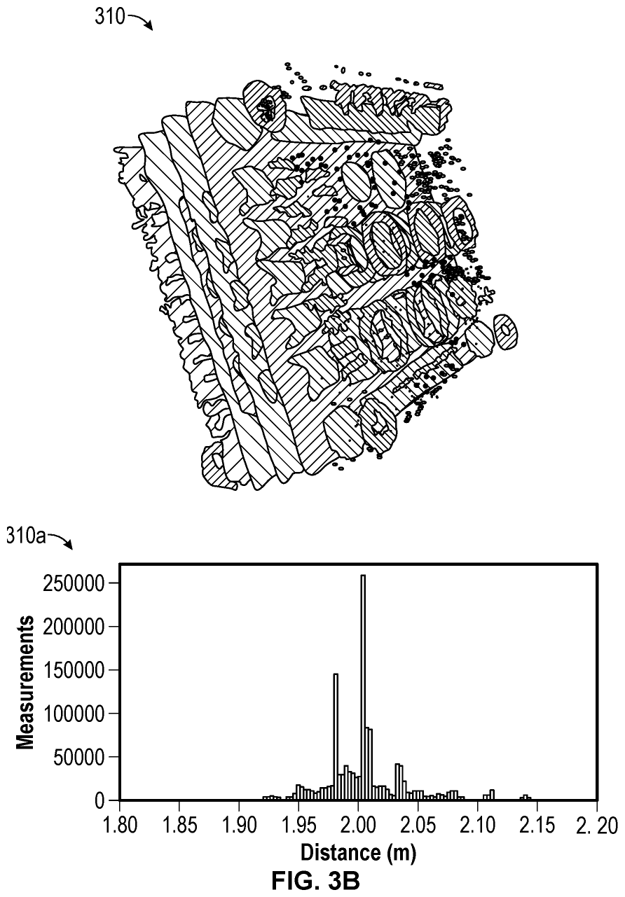

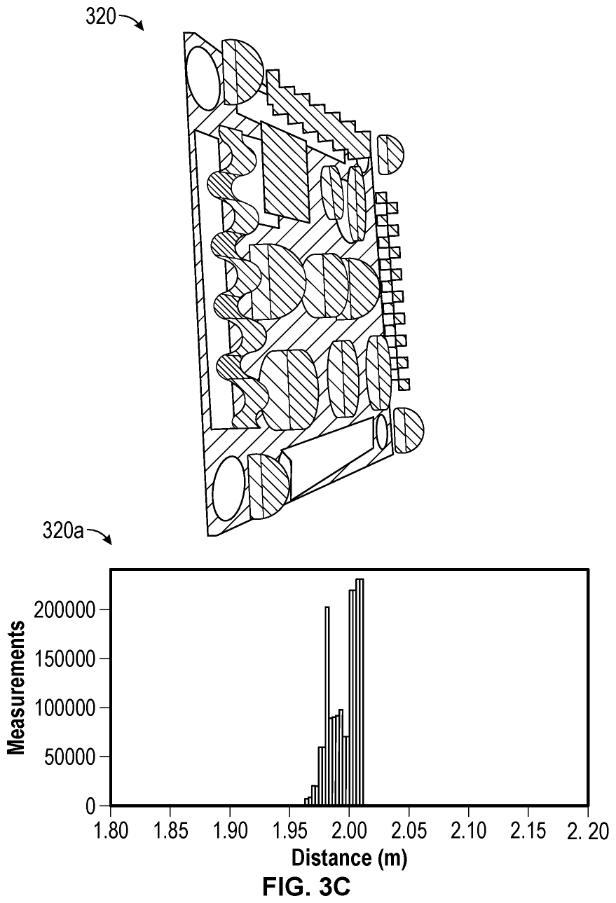

FIGS. 3A-3C are diagrams of an example 300 associated with LIDAR measurement using a polarizing optic.

FIG. 3A shows an example of a target 300 for LIDAR measurement. The target 300 may correspond to the target 180 of FIG. 1 or the target 220 of FIG. 2. FIG. 3B shows a point cloud 310 and a diagram 310a generated for the target 300 at a distance of approximately 2 meters using a first LIDAR measurement system that does not include a polarization beam combiner, a waveplate, and/or a linear polarizer in the configuration of the optical system 100 or the electro-optical system 200. The point cloud 310 is generated using −44 decibel-milliwatts (dBm) of optical noise. The diagram 310a illustrates a set of distance measurements corresponding to the point cloud 310. In contrast, FIG. 3C shows a point cloud 320 and a diagram 320a generated for the target 300 at a distance of approximately 2 meters using a second LIDAR measurement system that includes a polarization beam combiner, a waveplate, and a linear polarizer, such as the optical system 100 or the electro-optical system 200. The point cloud 320 is generated using −58 dBm of optical noise. The diagram 320a illustrates a set of distance measurements corresponding to the point cloud 320. The point cloud 320 and the diagram 320a show a reduction in image artifacts relative to the point cloud 310 and the diagram 310a as a result of a decreased noise floor of about 14 dB and a resultant polarization provided by the polarization beam combiner, waveplate, and linear polarizer used for controlling an optical beam.

As indicated above, FIGS. 3A-3C are provided as an example. Other examples may differ from what is described with regard to FIGS. 3A-3C.

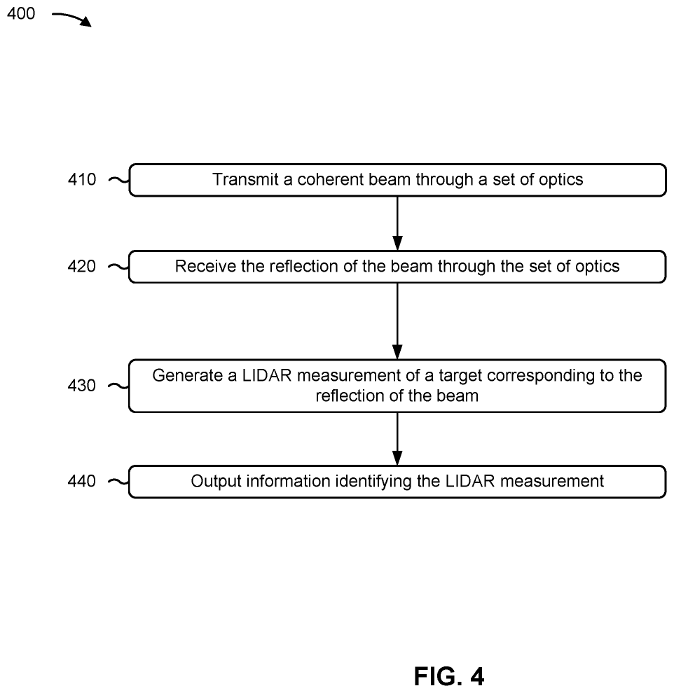

FIG. 4 is a flowchart of an example process 400 associated with polarizing optic for coherent LIDAR. In some implementations, one or more process blocks of FIG. 4 are performed by an electro-optical system (e.g., the electro-optical system 200). In some implementations, one or more process blocks of FIG. 4 are performed by another device or a group of devices separate from or including the electro-optical system, such as an optical system (e.g., the optical system 100) or a component thereof.

As shown in FIG. 4, process 400 may include transmitting a coherent beam through a set of optics (block 410). For example, the electro-optical system may transmit a coherent beam through a set of optics, as described above. In some implementations, the coherent beam may include an AM LIDAR type of optical beam with a pattern modulated onto the beam, such as one or more sinusoidal patterns modulated on to the beam. In some implementations, the set of optics may include a polarization beam splitter, a waveplate, and/or a linear polarizer to provide polarization selectivity of a particular polarization state. In some implementations, other optics included in the electro-optical system may include an optical relaying component, an optical expanding component, an optical focusing component, or an optical scanning component. In this case, the set of optics may block back-reflection from the other optics, thereby improving polarization selectivity and avoiding noise associated with the back-reflections.

As further shown in FIG. 4, process 400 may include receiving the reflection of the beam through the set of optics (block 420). For example, the electro-optical system may receive the reflection of the beam through the set of optics, as described above. The set of optics may rotate and control a polarization state of the reflection of the beam, such that a configured polarization state is incident on a receiver of the electro-optical system and other polarization states are blocked from being incident on the receiver of the electro-optical system.

As further shown in FIG. 4, process 400 may include generating a LIDAR measurement of a target corresponding to the reflection of the beam (block 430). For example, the electro-optical system may generate a LIDAR measurement of the target corresponding to the reflection of the beam, as described above. In some implementations, the electro-optical system may generate a point cloud determination (e.g., a three-dimensional point cloud representation of the target), an object recognition of the target, a gesture recognition of the target, or a three-dimensional sensing determination of the target. In some implementations, the electro-optical system may output the LIDAR measurement of the target and a separate system may generate a determination regarding the target (e.g., a gesture recognition) using the output.

As further shown in FIG. 4, process 400 may include outputting information identifying the LIDAR measurement (block 440). For example, the electro-optical system may output information identifying the LIDAR measurement, as described above. In some implementations, the electro-optical system may output the LIDAR measurement, a determination regarding the LIDAR measurement, or a control signal that is based on the LIDAR measurement or the determination regarding the LIDAR measurement.

Process 400 may include additional implementations, such as any single implementation or any combination of implementations described below and/or in connection with one or more other processes described elsewhere herein.

In a first implementation, the information identifying the LIDAR measurement includes ranging information identifying a distance of the target from the electro-optical system.

In a second implementation, alone or in combination with the first implementation, the information identifying the LIDAR measurement includes at least one of a point cloud determination relating to the target, an object recognition of the target, a gesture recognition of the target, or a three-dimensional sensing determination relating to the target.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of”' a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical system for LIDAR sensing, comprising:
a transmitter configured to transmit an amplitude modulation beam;
a polarization beam splitter configured to block a first polarized transmission component of the beam and pass through a second polarized transmission component of the beam;
a waveplate configured to convert the second polarized transmission component of the beam to a circular polarization state and to direct the beam toward a target,
wherein the waveplate is configured to receive a return reflection of the beam and convert the return reflection of the beam to a second polarized reflection component, and
wherein the polarization beam splitter is configured to reflect the second polarized reflection component and pass through a first polarized reflection component of the return reflection of the beam;
a linear polarizer configured to pass through the second polarized reflection component; and
a coherent receiver configured to receive the return reflection of the beam from the linear polarizer.

2. The optical system of claim 1, further comprising:
a splitting component to split the beam into a sample path and a local oscillator path,
the sample path being directed toward the polarization beam splitter.

3. The optical system of claim 1, further comprising:
a Mach-Zehnder modulator to modulate the beam and direct the beam toward the polarization beam splitter.

4. The optical system of claim 1, further comprising:
an amplifier component to amplify the beam and direct the beam toward the polarization beam splitter.

5. The optical system of claim 1, wherein the coherent receiver is configured to detect the beam and convert optical in-phase and quadrature-phase components of the beam to an analog signal.

6. The optical system of claim 1, further comprising:
an analog coherent optic to output the beam along a fiber toward the polarization beam splitter.

7. The optical system of claim 6, wherein the analog coherent optic includes at least one of the transmitter or the coherent receiver.

8. The optical system of claim 1, further comprising:
an erbium doped fiber array (EDFA) to amplify the beam.

9. The optical system of claim 1, further comprising:
a set of lenses to collimate, expand, and focus the beam.

10. The optical system of claim 1, further comprising:
a scanning component to scan the beam across the target.

11. The optical system of claim 1, further comprising:
a time-of-flight determination component to perform a measurement associated with an output of the coherent receiver corresponding to the beam.

12. The optical system of claim 1, wherein the waveplate is a liquid crystal waveplate.

13. An optical system, comprising:
a polarization beam splitter;
a waveplate;
a linear polarizer;
a coherent receiver; and
a transmitter to transmit an amplitude modulation beam along an optical path,
wherein the optical path extends through the polarization beam splitter and the waveplate and toward a target, extends back through the waveplate, reflects off the polarization beam splitter, and extends through the linear polarizer to the coherent receiver.

14. The optical system of claim 13, further comprising:
an isolator aligned between the transmitter and the polarization beam splitter,
wherein another optical path extends through the polarization beam splitter and the waveplate, reflects off the target, extends back through the waveplate, and extends through the polarization beam splitter to the isolator.

15. The optical system of claim 13, further comprising:
one or more optical components disposed between the polarization beam splitter and the waveplate in the optical path.

16. The optical system of claim 15, wherein the one or more optical components include at least one of:
an optical relaying component,
an optical expanding component,
an optical focusing component, or
an optical scanning component.

17. The optical system of claim 13, wherein an extinction ratio of the optical system along the optical path is at least a 3000:1 extinction of a configured polarization state.

18. A method, comprising:
transmitting, by a transmitter of an electro-optical system, a beam through a set of optics,
wherein the set of optics includes:
a polarization beam splitter configured to block a first polarized transmission component of the beam and pass through a second polarized transmission component of the beam;
a waveplate configured to convert the second polarized transmission component of the beam to a circular polarization state and to direct the beam toward a target,
wherein the waveplate is configured to receive a return reflection of the beam and convert the return reflection of the beam to a second polarized reflection component, and
wherein the polarization beam splitter is configured to reflect the second polarized reflection component and pass through a first polarized reflection component of the return reflection of the beam; and
a linear polarizer configured to pass through the second polarized reflection component; and
receiving, by a receiver of the electro-optical system, the return reflection of the beam from the linear polarizer;
generating, by a controller of the electro-optical system, a LIDAR measurement of the target using an output of the receiver corresponding to the return reflection of the beam; and
outputting, by an output component of the electro-optical system, information identifying the LIDAR measurement.

19. The method of claim 18, wherein the information identifying the LIDAR measurement includes ranging information identifying a distance of the target from the electro-optical system.

20. The method of claim 18, wherein the information identifying the LIDAR measurement includes at least one of:
a point cloud determination relating to the target,
an object recognition of the target,
a gesture recognition of the target, or
a three-dimensional sensing determination relating to the target.
